(19) United States
(12) Patent Application Publication
(10) Pub. No.: US 2024/0421518 A1
(43) Pub. Date: Dec. 19, 2024

(54) ELECTRICAL CONNECTOR

(71) Applicant: LOTES CO., LTD, Keelung (TW)

(72) Inventor: Jia Ren Duan, Keelung (TW)

(21) Appl. No.: 18/675,301

(22) Filed: May 28, 2024

(30) Foreign Application Priority Data
Jun. 16, 2023 (CN) 202321562766.X
Oct. 12, 2023 (CN) 202322746447.0

(51) Int. Cl. H01R 12/70; H01R 13/24

(52) U.S. Cl. CPC H01R 12/7076; H01R 12/707; H01R 13/2407; H01R 13/2471

(57) ABSTRACT

An electrical connector includes an insulating body having accommodating slots and terminals accommodated in the accommodated slots. Each terminal has a body portion, a first elastic arm, a separation provided on the first elastic arm and the body portion, and a second elastic arm having at least one end integrally connected to a corresponding end of the separation. A left side edge or a right side edge of the body portion has a strip connecting edge to be connected to a strip. Each of left and right side edges of the separation has a first edge and a second edge located below the first edge. The second edge protrudes inward toward the separation relative to the first edge, such that the upper end of the body portion forms an abutting region for a jig to abut against each terminal to be assembled downward in a corresponding accommodating slot.

### CROSS-REFERENCE TO RELATED PATENT APPLICATION

This non-provisional application claims priority to and the benefit of, pursuant to 35 U.S.C. § 119 (a), patent application Serial No. CN202321562766.X filed in China on Jun. 16, 2023, and patent application Serial No. CN202322746447.0 filed in China on Oct. 12, 2023. The disclosure of each of the above applications is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector, and particularly to an electrical connector with higher terminal density.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The Chinese Patent Application No. CN202022460382.X discloses an electrical connector, which includes an insulating body and a plurality of terminals accommodated in the insulating body. Each terminal has a base portion positioned in the insulating body, an elastic arm formed by extending upward from the base portion, two strip connecting portions formed by extending upward from an upper end of the base portion and located at a left side and a right side of the elastic arm, and a through slot running through the elastic arm along a thickness of the elastic arm. The two strip connecting portions are configured to be connected to a strip. The through slot allows the elastic arm to form two first branches at a left side and a right side of the through slot, and the two first branches are located at a left side and a right side of a second branch. During assembly of the terminals, each strip is connected to a row of the terminals to be inserted downward into the insulating body, and the strip is removed after the terminals are assembled.

However, the upper ends of the left and right sides of the base portion of each terminal both extend upward to form strip connecting portions, such that a width of the terminal in the left-right direction is greater, which results in the volume of the terminal being larger, which is not suitable for an electrical connector with higher terminal density and higher requirement in high frequency characteristics. Further, the strip is removed after the terminals are assembled, which requires pre-breaking at the strip connecting portions of the terminal, thus resulting in the terminals easily falling from the strip in the electroplating and transferring processes.

Therefore, a heretofore unaddressed need to design a new electrical connector exists in the art to address the aforementioned deficiencies and inadequacies.

### SUMMARY

The present invention is directed to an electrical connector with higher terminal density and stronger high frequency characteristics.

To achieve the foregoing objective, the present invention adopts the following technical solutions.

An electrical connector is configured to electrically connect a mating component to a circuit board. The electrical connector includes: an insulating body, having a plurality of accommodating slots running vertically through the insulating body; and a plurality of terminals, respectively accommodated in the accommodating slots. Each terminal includes: a body portion, with a left side edge and a right side edge, wherein one of the left side edge and the right side edge has a strip connecting edge configured to be connected to a strip; a first elastic arm, formed by bending and extending from an upper end of the body portion, wherein a top portion of the first elastic arm has a mating portion configured to abut upward against the mating component, and the mating portion is located in front of a bending location of the first elastic arm connected to the body portion; a separation, provided on the body portion and the first elastic arm, wherein the separation divides the first elastic arm into two sub-arms separated in the left-right direction and divides the body portion into two branches separated in the left-right direction, each of a left side edge and a right side edge of the separation has a first edge and a second edge located below the first edge, the second edge protrudes inward toward the separation relative to the first edge, such that an abutting region is formed between a bottom edge of the first edge and a top edge of the second edge for a jig to abut against each of the terminals to be assembled downward in a corresponding one of the accommodating slots; and a second clastic arm, wherein the two sub-arms and the two branches are located respectively at a left side and a right side of the second elastic arm, at least one end of the second elastic arm and a corresponding end of the separation are integrally connected, and when the mating component abuts downward against the mating portion to a final location, a conductive path sequentially through the mating portion, the sub-arm at the left side of the second elastic arm and the branch at the left side of the second elastic arm, another conductive path sequentially through the mating portion, the sub-arm at the right side of the second elastic arm and the branch at the right side of the second elastic arm, and a further conductive path sequentially through the mating portion, the second elastic arm and the body portion are formed between the mating component and the circuit board.

In certain embodiments, the first edge and the second elastic arm are formed to be separate from each other by blanking, the second edge and the second elastic arm are formed to be separate from each other by tearing, the abutting region is in an arc shape, and a connecting location of the abutting region and the second edge is higher than a lowest point of the arc shape.

In certain embodiments, each of the left side edge and the right side edge of the separation further has a third edge located below the second edge, the third edge extends upward from a lower end of the separation, and the third edge and the second elastic arm are formed to be separate from each other by blanking.

In certain embodiments, an oblique edge extends downward from the second edge to the third edge, the oblique edge and the second elastic arm are formed to be separate from each other by tearing, and a gap between two oblique edges at a left side and a right side of the separation gradually increases downward from top thereof.

In certain embodiments, a lower end of the second elastic arm and a lower end of the separation are integrally connected, an upper end of the second elastic arm and an upper end of the separation are broken and the second elastic arm has a contact portion, a surface of the contact portion and a surface of the mating portion are gold-plated, and a gold-plating thickness of the mating portion is greater than a gold-plating thickness of the contact portion.

In certain embodiments, the first edge and the second elastic arm are formed to be separate from each other by blanking, the body portion is provided with a pair of clamping portions configured to clamp a solder ball, and viewing downward from top thereof, a gap exists between the first edge and the second elastic arm, and the solder ball is partially exposed in the gap.

In certain embodiments, a lower end of the second elastic arm and a lower end of the separation are integrally connected, an upper end of the second elastic arm and an upper end of the separation are broken and the second elastic arm has a contact portion; when the mating component abuts against the mating portion to the final location, the contact portion is in contact with the first elastic arm; a contact location of the contact portion and the first elastic arm is located between the separation and the mating portion; each of a left side edge and a right side edge of the first elastic arm has a tapered edge, a spacing between two tapered edges gradually decreases forward from rear thereof, and a highest point of the separation is located between the two tapered edges.

In certain embodiments, each of a left side edge and a right side edge of the first elastic arm has a tapered edge, and a spacing between two tapered edges gradually decreases forward from rear thereof; an upper surface of the insulating body is protrudingly provided with a plurality of protruding blocks, each of the protruding blocks has a supporting surface configured to support the mating component, and when the mating component abuts downward against the mating portion to the final location, viewing downward from top thereof, the tapered edge is located between two adjacent supporting surfaces, and a rear edge of the supporting surface is located in front of a rear edge of the tapered edge.

In certain embodiments, a lower end of the second elastic arm and a lower end of the separation are integrally connected; the body portion comprises a base portion and a pair of clamping portions extending vertically downward from the base portion to clamp a solder ball, the base portion is in a vertical flat plate shape and a front surface and a rear surface thereof are plate surfaces, and the first elastic arm is connected to an upper end of the base portion.

In certain embodiments, each solder ball is stopped forward by a first stopping block and is stopped backward by two second stopping blocks, the first stopping block and the second stopping blocks are provided on the insulating body, the first stopping block is located in front of the clamping portions, and the second stopping blocks are located behind the clamping portions.

In certain embodiments, the first edge extends upward from the bending location of the first elastic arm connected to the body portion, and the second edge extends downward from the upper end of the body portion.

In certain embodiments, an upper end of the second elastic arm and an upper end of the separation are integrally connected, a lower end of the second elastic arm and a lower end of the separation are integrally connected, the second elastic arm has a first portion and a second portion, the first portion protrudes upward relative to the sub-arms, the second portion protrudes forward relative to the branches, the two sub-arms are located respectively at a left side and a right side of the first portion, and the two branches are located respectively at a left side and a right side of the second portion.

The present invention further adopts the following technical solutions.

An electrical connector includes: an insulating body, having a plurality of accommodating slots running vertically through the insulating body; and a plurality of terminals, respectively accommodated in the accommodating slots. Each terminal includes: a base portion, being in a vertical flat plate shape and having a front surface and a rear surface thereof being plate surfaces; a first elastic arm, formed by bending and extending from an upper end of the base portion, wherein a top portion of the first elastic arm has a mating portion configured to abut upward against a mating component, and the mating portion is located in front of the base portion; a separation, provided on the base portion and the first elastic arm, wherein the separation divides the first elastic arm into two sub-arms separated in the left-right direction and divides the base portion into two branches separated in the left-right direction, a left corner and a right corner of an upper end of the separation have two first arc edges, the upper end of the separation has a second arc edge between the two first arc edges, the second arc edge is connected to the two first arc edges, a highest point of the two first arc edges is higher than a connecting point of each of the first arc edges and the second arc edge, and a highest point of the second arc edge is higher than the highest point of the first arc edges; and a second elastic arm, wherein the second elastic arm and a lower end of the separation are integrally connected, an upper end of the second elastic arm is integrally connected to the second arc edge before forming and is broken from the second arc edge after forming, each of a left side edge and a right side edge of the separation has a first edge extending downward from the first arc edge, the first arc edge, the first edge and the second elastic arm are formed to be separate from one another by blanking, the second elastic arm has a contact portion, and when the mating component abuts downward against the mating portion to a final location, the contact portion is in contact with the first elastic arm, and a contact location of the contact portion and the first elastic arm is located in front of the separation.

In certain embodiments, the first edge has a first section connected to the first arc edge, a second section extending obliquely downward from the first section and approaching the separation and a third section extending downward from the second section to the upper end of the base portion, and a distance between two first sections at a left side and a right side of the separation is greater than a distance between two third sections at the left side and the right side of the separation.

In certain embodiments, each of a left side and a right side of the first elastic arm has a tapered edge, a spacing between two tapered edges gradually decreases forward from rear thereof, the highest point of the second arc edge is higher than a lowest point of the tapered edge but is lower than a highest point of the tapered edge, and the contact location of the contact portion and the first elastic arm is located between the separation and the mating portion.

In certain embodiments, each of a left side edge and a right side edge of the first elastic arm has a tapered edge, and a spacing between two tapered edges gradually decreases forward from rear thereof; an upper surface of the insulating body is protrudingly provided with a plurality of protruding blocks, each of the protruding blocks has a supporting surface configured to support the mating component, and when the mating component abuts downward against the mating portion to the final location, viewing downward from top thereof, the tapered edge is located between two adjacent supporting surfaces, and a rear edge of the supporting surface is located in front of a rear edge of the tapered edge.

In certain embodiments, when the mating component does not abut against the mating portion, the contact portion is not in contact with the first elastic arm; a surface of the contact portion and a surface of the mating portion are gold-plated, and a gold-plating thickness of the mating portion is greater than a gold-plating thickness of the contact portion.

In certain embodiments, a pair of clamping portions extend from the base portion and are configured to clamp a solder ball, and viewing downward from top thereof, the solder ball is partially exposed in the separation.

In certain embodiments, a pair of clamping portions extend vertically downward from the base portion and are configured to clamp a solder ball.

The present invention further adopts the following technical solutions.

An electrical connector includes: an insulating body, having a plurality of accommodating slots running vertically through the insulating body; and a plurality of terminals, respectively accommodated in the accommodating slots. Each terminal includes: a base portion, being in a vertical flat plate shape and having a front surface and a rear surface thereof being plate surfaces; a first elastic arm, formed by bending and extending from an upper end of the base portion, wherein a top portion of the first elastic arm has a mating portion configured to abut upward against a mating component, and the mating portion is located in front of a bending location of the first elastic arm connected to the base portion; and a separation, provided on the base portion and the first elastic arm, wherein the separation divides the first elastic arm into two sub-arms separated in the left-right direction and divides the base portion into two branches separated in the left-right direction, each of a left side edge and a right side edge of the separation has a first edge and a second edge located below the first edge, the first edge extends upward from the bending location of the first elastic arm connected to the base portion, the second edge extends downward from the upper end of the base portion, and the second edge protrudes inward toward the separation relative to the first edge, such that the upper end of the base portion forms an abutting region between a bottom edge of the first edge and a top edge of the second edge for a jig to abut against each of the terminals to be assembled downward in a corresponding one of the accommodating slots; and a jig accommodating space is formed between two second edges at the left side edge and the right side edge, allowing the jig to enter the jig accommodating space to adjust locations of the terminals in the left-right direction.

Compared to the related art, certain embodiments of the present invention have the following beneficial effects:

Each terminal has a strip connecting edge at a left side edge or a right side edge of the body portion to be connected to a strip, such that a width of the terminal in the left-right direction is shorter, and the volume of the terminal is thereby smaller, which is suitable for an electrical connector with higher terminal density and higher requirement in high frequency characteristics. Further, the strip is removed before the terminals are assembled into the accommodating slots, and the terminals are then assembled into the accommodating slots by a jig abutting against the abutting region between the bottom edge of the first edge and the top edge of the second edge. Thus, there is no need to perform pre-breaking at the strip connecting edges, and the terminals do not easily fall from the strip connecting edges in the electroplating and transferring processes.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective view of an electrical connector according to a first embodiment of the present invention.

FIG. 2 is a top view of FIG. 1.

FIG. 3 is a top view of the mating component abutting downward against the terminals to a final location.

FIG. 4 is a sectional view of FIG. 3 along a line A-A.

FIG. 5 is a perspective view of FIG. 1 from another angle.

FIG. 6 is plain view of FIG. 1 before the terminals are formed.

FIG. 7 is a perspective view of a terminal in FIG. 1.

FIG. 8 is a side view of FIG. 7.

FIG. 9 is a rear view of FIG. 7.

FIG. 10 is an enlarged view of a region B in FIG. 9.

FIG. 11 is a schematic view of the terminals being abutted by the jig and assembled in the accommodating slots in FIG. 1.

FIG. 12 is a schematic view of the terminals after being assembled in the accommodating slots in FIG. 11.

FIG. 13 is a perspective view of an electrical connector according to a second embodiment of the present invention.

FIG. 14 is a side view of FIG. 13.

FIG. 15 is a rear view of FIG. 13.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated. As used herein, the terms “comprising”, “including”, “carrying”, “having”, “containing”, “involving”, and the like are to be understood to be open-ended, i.e., to mean including but not limited to.

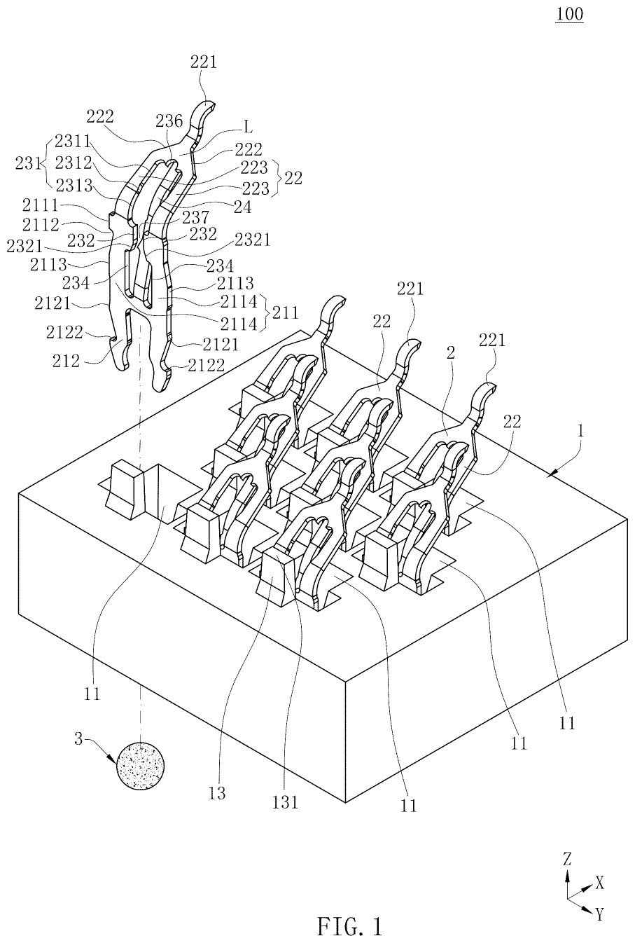

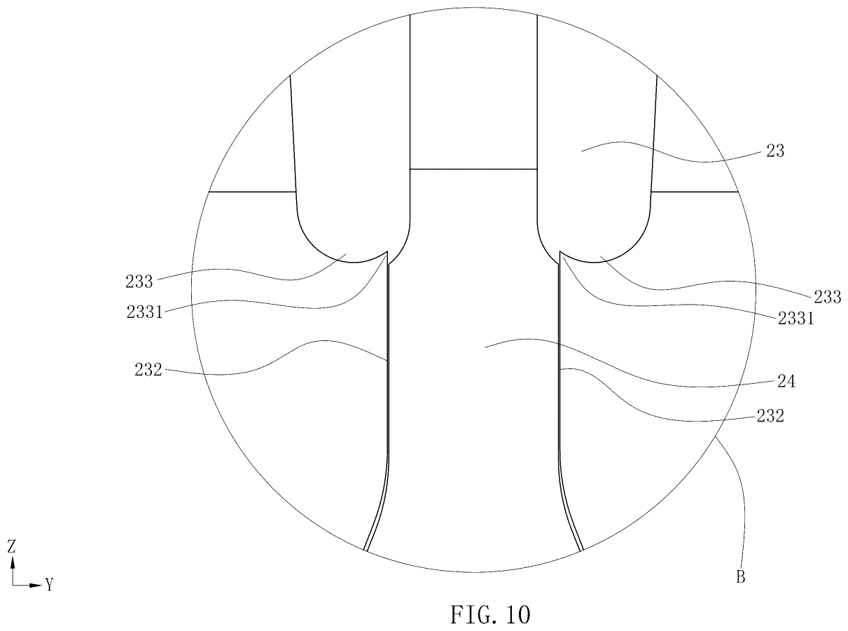

The description will be made as to the embodiments of the present invention in conjunction with the accompanying drawings in FIGS. 1-15. In accordance with the purposes of this invention, as embodied and broadly described herein, this invention, in one aspect, relates to an electrical connector.

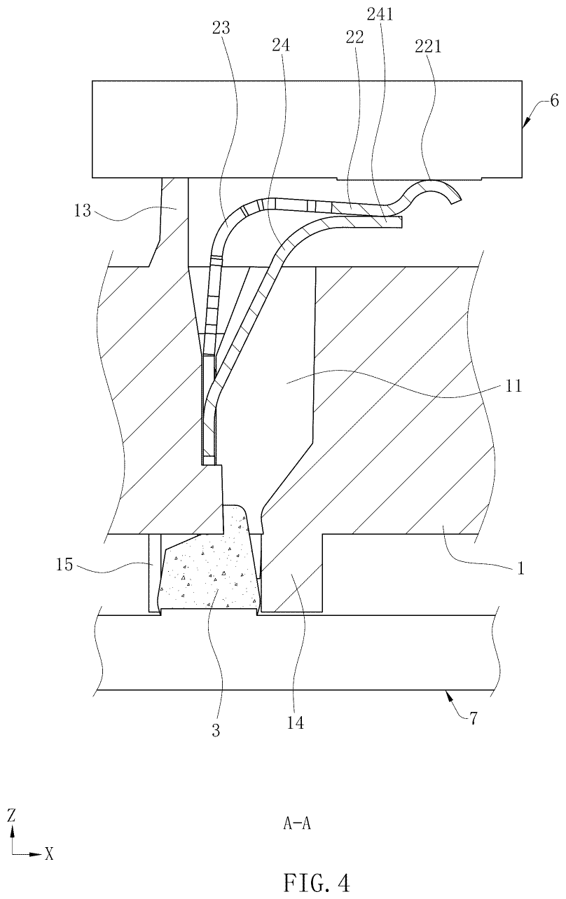

FIG. 1 and FIG. 4 show an electrical connector 100 according to a first embodiment of the present invention. The electrical connector 100 includes an insulating body 1, a plurality of terminals 2 and a plurality of solder balls 3. The insulating body 1 has a plurality of accommodating slots 11 running vertically therethrough. Each terminal 2 is correspondingly accommodated in each accommodating slot 11. Each terminal 2 clamps one of the solder balls 3. By soldering the solder balls 3, the terminals 2 are soldered onto a circuit board 7. (In the figures, an extending direction of the X-axis is a front-rear direction, where the positive direction of the X-axis is the forward direction; an extending direction of the X-axis is a left-right direction, where the positive direction of the Y-axis is the rightward direction; an extending direction of the Z-axis is a vertical direction, where the positive direction of the Z-axis is the upward direction.)

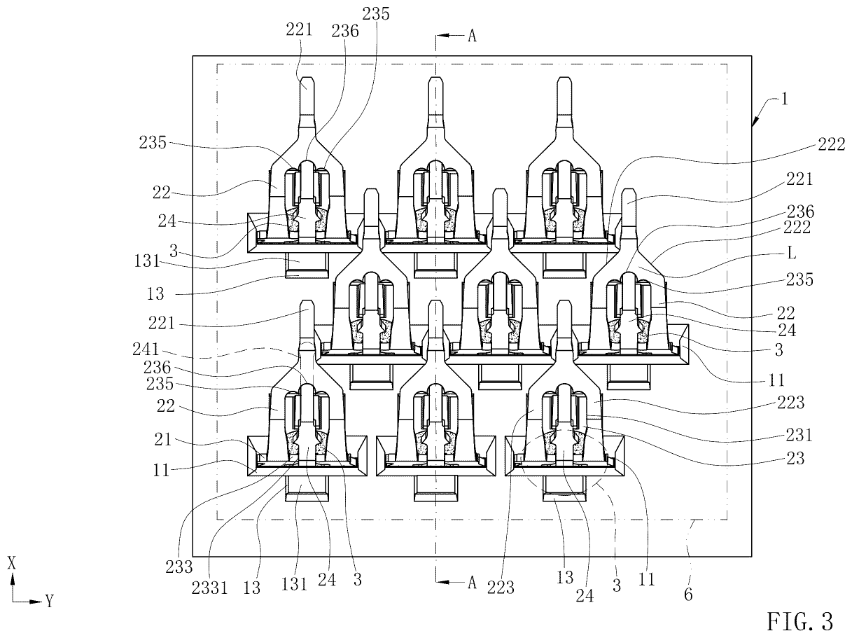

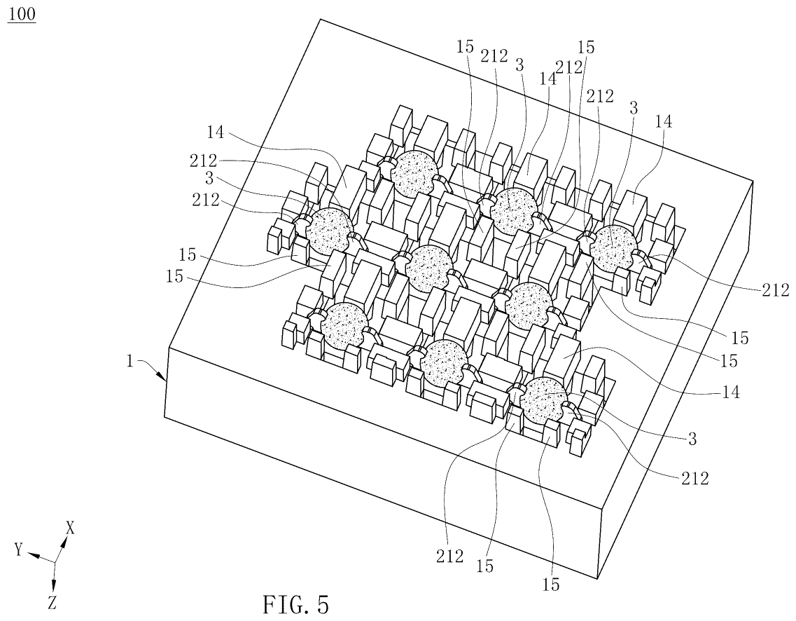

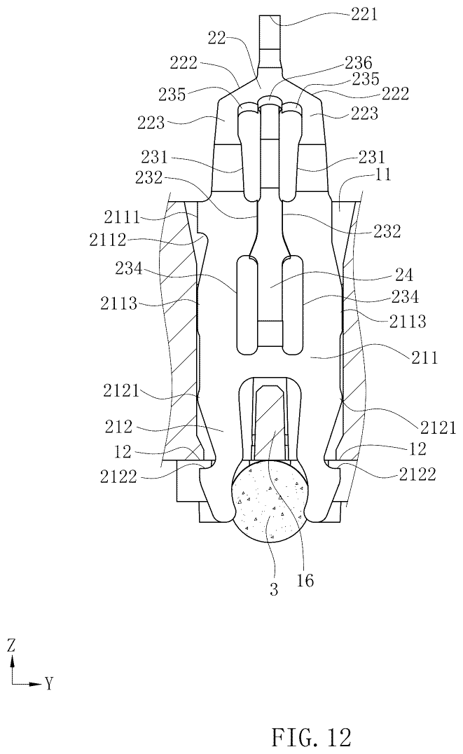

Referring to FIG. 3, FIG. 5 and FIG. 12, the accommodating slots 11 are provided side by side in the left-right direction and staggered in the front-rear direction. Each accommodating slot 11 is provided with a protruding portion 16 therein, and the protruding portion 16 is located above a corresponding solder ball 3 to stop the solder ball 3 from moving upward. An upper surface of the insulating body 1 is protrudingly provided with a plurality of protruding blocks 13, and each protruding block 13 is located behind a corresponding accommodating slot 11. Each protruding block 13 has a supporting surface 131 configured to support the mating component 6. A lower surface of the insulating body 1 is provided with a stopping surface 12 stopping the terminals 2 and a plurality of first stopping blocks 14 and a plurality of second stopping blocks 15 for stopping the solder balls 3.

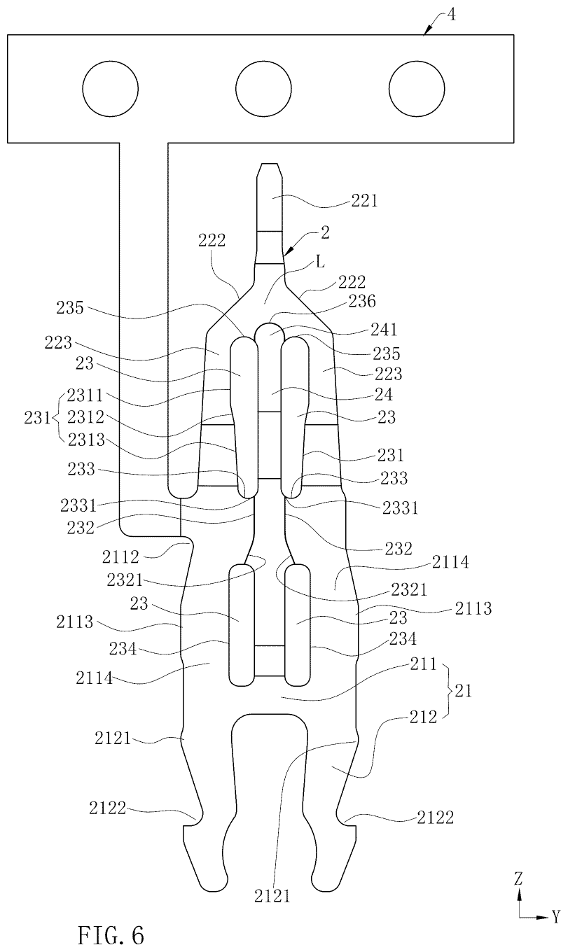

Referring to FIG. 5, FIG. 6 and FIG. 12, each terminal 2 includes a body portion 21. The body portion 21 includes a base portion 211 and a pair of clamping portions 212 formed by extending vertically downward from the base portion 211 to clamp a corresponding solder ball 3. In the present embodiment, the clamping portions 212 clamp at the midpoint of the solder ball 3 (that is, an extending line of the diameter of the solder ball 3 passes through the pair of clamping portions 212), and the protruding portion 16 enters between the pair of clamping portions 212. The base portion 211 is in a vertical flat plate shape and a front surface and a rear surface thereof are plate surfaces. In the present embodiment, front surfaces of the clamping portions 212 and the front surface of the base portion 211 are located on a same plane, and/or rear surfaces of the clamping portions 212 and the rear surface of the base portion 211 are located on a same plane, or a central surface of the clamping portions 212 in the front-rear direction and a central surface of the base portion 211 are located on a same plane (and in other embodiments, it is possible that the clamping portions 212 are formed by extending obliquely downward from the base portion 211), thereby the body portion 21 is in a vertical flat plate shape (and in other embodiments, it is possible that the body portion 21 is not in the flat plate shape and has a bending structure, and it is possible that the body portion 21 is not provided with the clamping portions 212 to clamp the solder ball 3, for example, the body portion 21 may be directly inserted into the circuit board 7, or the body portion 21 and the circuit board 7 are in clastic contact vertically), and in the front-rear direction, the body portion 21 is stopped by the corresponding inner wall of the accommodating slot 11 to limit the body portion 21 from moving in the front-rear direction. The base portion 211 has a strip connecting edge 2111 at a left side edge or a right side edge thereof to be connected to a strip 4. The base portion 211 has a notch 2112 below the strip connecting edge 2111. The notch 2112 is connected to the strip connecting edge 2111, and the notch 2112 is reserved for clearance for a cutting tool when cutting the strip 4. The base portion 211 is protrudingly provided with a first position limiting portion 2113 at the left side edge and the right side edge thereof below the notch 2112. A side edge of each clamping portion 212 is protruding provided with a second position limiting portion 2121. Along the left-right direction, the first position limiting portion 2113 and the second position limiting portion 2121 are respectively stopped by the corresponding inner wall of the accommodating slot 11 to limit the body portion 21 from moving in the left-right direction. Each clamping portion 212 is provided with a recess 2122, and a bottom surface of the recess 2122 is stopped by the stopping surface 12 of the insulating body 1 to stop the clamping portion 212 from moving upward. Each first stopping block 14 is located in front of the clamping portions 212 and stops the solder ball 3 from moving forward, and each second stopping block 15 is located behind the clamping portions 212 and stops the solder ball 3 from moving backward.

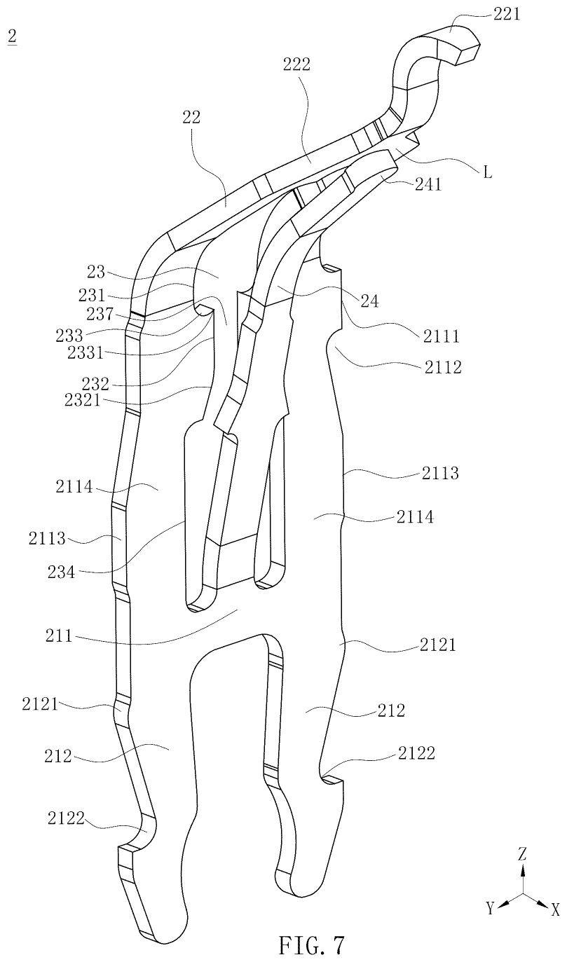

Referring to FIG. 4, FIG. 6 and FIG. 7, a first elastic arm 22 is formed by bending and extending from an upper end of the body portion 21. A top portion of the first elastic arm 22 has a mating portion 221 configured to abut upward against the mating component 6, and the mating portion 221 is located in front of a bending location of the first elastic arm 22 connected to the body portion 21. A separation 23 is provided on the base portion 211 and the first elastic arm 22, divides the first elastic arm 22 into two sub-arms 223 separated in the left-right direction, and divides the base portion 211 into two branches 2114 separated in the left-right direction. The separation 23 is located above the clamping portions 212. Each of a left side edge and a right side edge of the separation 23 has a first edge 231 and a second edge 232 located below the first edge 231. The first edge 231 extends upward from the bending location of the first elastic arm 22 connected to the body portion 21. The second edge 232 extends downward from the upper end of the body portion 21, and the second edge 232 protrudes inward toward the separation 23 relative to the first edge 231, such that the upper end of the body portion 21 forms an abutting region 233 between a bottom edge of the first edge 231 and a top edge of the second edge 232 for a jig 5 to abut against the terminals 2 to be assembled downward in the accommodating slots 11. In other embodiments, it is possible that the bottom edge of the first edge 231 is lower than the bending location of the first elastic arm 22 connected to the body portion 21, and the top edge of the second edge 232 is lower than the upper end of the body portion 21, such that the abutting region 233 is lower than the upper end of the body portion 21.

Referring to FIG. 1, FIG. 4, FIG. 6 and FIG. 7, each terminal 2 further includes a second elastic arm 24. The two sub-arms 223 and the two branches 2114 are located respectively at a left side and a right side of the second clastic arm 24, and a lower end of the second elastic arm 24 and a lower end of the separation 23 are integrally connected. The second elastic arm 24 has a contact portion 241. When the mating component 6 abuts downward against the mating portion 221 to a final location, the contact portion 241 is in contact with the first elastic arm 22 (and in other embodiments, it is also possible that the upper end of the second elastic arm 24 and an upper end of the separation 23 are integrally connected, and in this case, and when the mating component 6 abuts downward against the mating portion 221 to the final location, the contact portion 241 is in contact with the body portion 21), thereby a conductive path sequentially through the mating portion 221, the sub-arm 223 at the left side of the second elastic arm 24 and the branch 2114 at the left side of the second elastic arm 24, another conductive path sequentially through the mating portion 221, the sub-arm 223 at the right side of the second elastic arm 24 and the branch 2114 at the right side of the second elastic arm 24, and a further conductive path sequentially through the mating portion 221, the second elastic arm 24 and the body portion 21 are formed between the mating component 6 and the circuit board 7, and a contact location of the contact portion 241 and the first elastic arm 22 is located between the separation 23 and the mating portion 221.

Referring to FIG. 1, FIG. 3 and FIG. 6, a connecting portion L is integrally connected to the two sub-arms 223. Each of a left side edge and a right side edge of the connecting portion L has a tapered edge 222, and a spacing between tapered edges 222 gradually decreases forward from rear thereof. When the mating component 6 abuts downward against the mating portion 221 to the final location, viewing downward from a top thereof, the tapered edges 222 are located between two adjacent supporting surfaces 131 in the left-right direction, and a rear edge of the supporting surface 131 is located in front of a rear edge of the tapered edge 222.

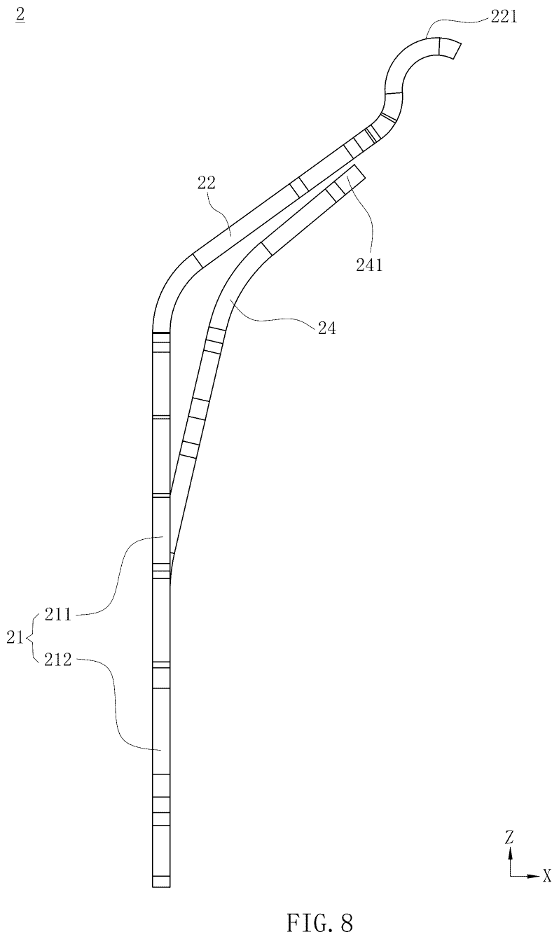

Referring to FIG. 4 and FIG. 8, a surface of the contact portion 241 and a surface of the mating portion 221 are gold-plated. In the process of the mating component 6 abutting downward against the mating portion 221, the mating portion 221 moves on the surface of the mating component 6 and generates friction. Since the movement of the mating portion 221 is greater than the movement of the contact portion 241, a gold-plating thickness of the mating portion 221 is greater than a gold-plating thickness of the contact portion 241. In the present embodiment, when the mating component 6 does not abut downward against the mating portion 221, the contact portion 241 is not in contact with the first elastic arm 22, allowing gold-plating on the contact portion 241. In other embodiments, when the mating component 6 does not abut downward against the mating portion 221, the contact portion 241 may be in contact with the first elastic arm 22.

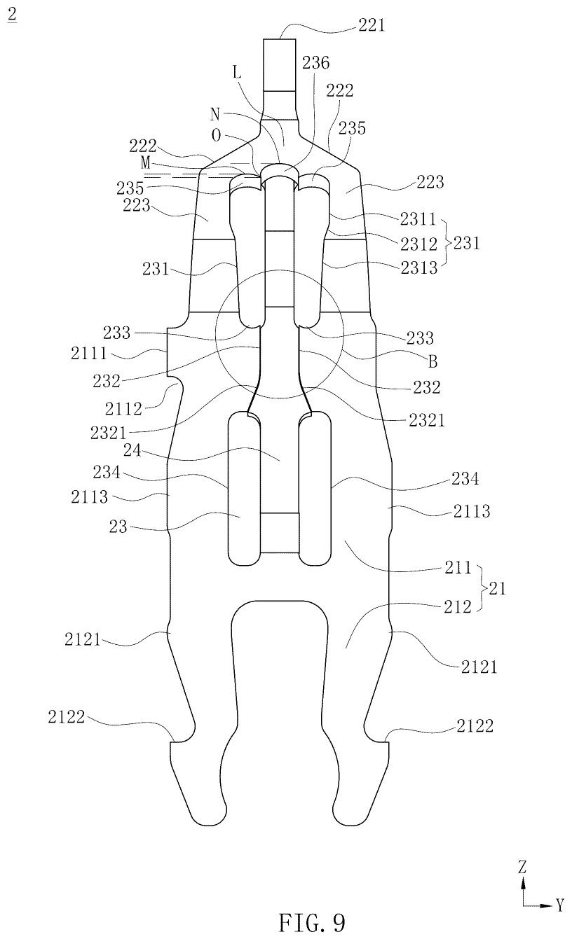

Referring to FIG. 1, FIG. 6 and FIG. 9, a left corner and a right corner of the upper end of the separation 23 have two first arc edges 235, and the upper end of the separation 23 has a second arc edge 236 between the two first arc edges 235. The second arc edge 236 is connected to the two first arc edges 235, and each first arc edge 235 is connected to the first edge 231. The first arc edges 235 and the second arc edge 236 are formed to be separate from the second elastic arm 24 by blanking with the second elastic arm 24. A highest point M of the first arc edges 235 is higher than a connecting point O of each first arc edge 235 and the second arc edge 236, and a highest point N of the second arc edge 236 is higher than the highest point M of the first arc edges 235. The highest point N of the second arc edge 236 is located between two tapered edges 222 (that is, the highest point N of the second arc edge 236 is higher than a lowest point of the tapered edges 222 but is lower than a highest point of the tapered edges 222). During blanking, the cutting edge of the mold is an arc surface corresponding to the first arc edges 235, thereby preventing the mold from providing a sharp corner near the location of the second elastic arm 24, thus prolonging the usage lifespan of the mold and preventing from wearing of the sharp corner and dropped waste material that may affect the performance of the terminals 2.

Referring to FIG. 1, FIG. 6 and FIG. 9, the first edge 231 has a first section 2311 connected to the first arc edge 235, a second section 2312 extending obliquely downward from the first section 2311 and approaching the separation 23 and a third section 2313 extending downward from the second section 2312 to the upper end of the base portion 21, and a distance between two first sections 2311 at a left side and a right side of the separation 23 is greater than a distance between two third sections 2313 at the left side and the right side of the separation 23, such that a width of a lower portion of each sub-arm 223 is greater than a width of an upper portion of the sub-arm 223.

Referring to FIG. 6 and FIG. 9 to FIG. 12, the first edge 231 and the second elastic arm 24 are formed to be separate from each other by blanking, and the second edge 232 and the second elastic arm 24 are formed to be separate from each other by tearing. The abutting region 233 is in an arc shape, and a connecting location of the abutting region 233 and the second edge 232 is higher than a lowest point of the arc shape, such that the abutting region 233 forms a protrusion 2331. When the terminals 2 are mounted, the jig 5 abuts against the protrusion 2331, and a location of the jig 5 abutting against each terminal 2 becomes higher, thereby reducing a gap between the jig 5 and the first edge 231. Thus, with the width of the jig 5 remaining unchanged, the jig 5 abutting against the protrusion 2331 may reduce the spacing between two first edges 231, such that the width of the separation 23 becomes narrower, thereby allowing the production of terminals with smaller volumes, which is suitable for the electrical connector with higher terminal density and higher requirement in high frequency characteristics.

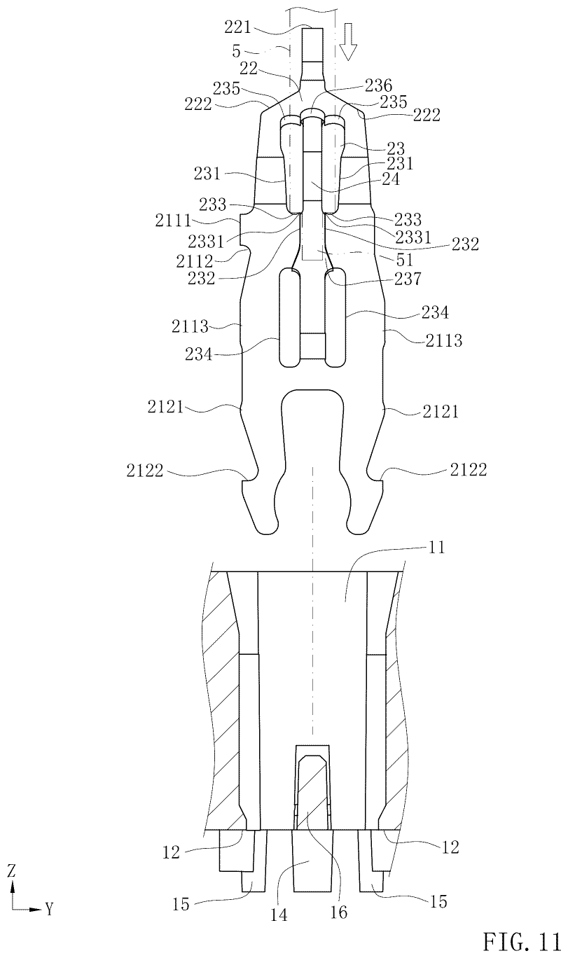

Referring to FIG. 4, FIG. 7 and FIG. 11, the first elastic arm 22 and the second elastic arm 24 are both located at a front side of the base portion 211 (and in other embodiments, the first elastic arm 22 may have a portion located at a rear side of the base portion 211 and another portion located at the front side of the base portion 211, and the second elastic arm 24 may also have a portion located at the rear side of the base portion 211 and another portion located at the front side of the base portion 211). The second elastic arm 24 protrudes forward relative to the body portion 21 and is thus staggered with the second edge 232 in the front-rear direction, such that a jig accommodating space 237 is formed between two second edges 232. A lower end portion of the jig 5 has an extending portion 51, and when the jig 5 abuts against the abutting region 233, the extending portion 51 enters the jig accommodating space 237, thereby adjusting the location of the terminal 2 in the left-right direction. In other embodiments, it is also possible that the jig 5 does not enter the space between the two second edges 232 in the left-right direction. Thus, the second elastic arm 24 may be located between the two second edges 232 without staggering with the second edge 232 in the front-rear direction. Alternatively, a distance between the two second edges 232 is shorter and thus insufficient for the jig 5 to enter therein.

Referring to FIG. 3, FIG. 6 and FIG. 7, each of the left side edge and the right side edge of the separation 23 further has a third edge 234 located below the second edge 232. The third edge 234 extends upward from a lower end of the separation 23, and the third edge 234 and the second elastic arm 24 are formed to be separate from each other by blanking. Thus, a gap exists between the third edge 234 and the second elastic arm 24. In other embodiments, it is also possible not to provide the third edge 234 located below the second edge 232 and formed to be separate from the second elastic arm 24 by blanking with the second elastic arm 24, and the second edge 232 extends downward to the lower end of the separation 23 from the upper end of the base portion 211. In other words, the base portion 211 connected to the side edge of the separation 23 and the second elastic arm 24 are formed to be separate from each other by tearing.

Referring to FIG. 1, FIG. 6 and FIG. 7, an oblique edge 2321 is formed by extending downward from the second edge 232. The oblique edge 2321 and the second elastic arm 24 are formed to be separate from each other by tearing, and a gap between two oblique edges 2321 at a left side and a right side of the separation 23 gradually increases downward from top thereof, thereby enhancing the strength of a punch.

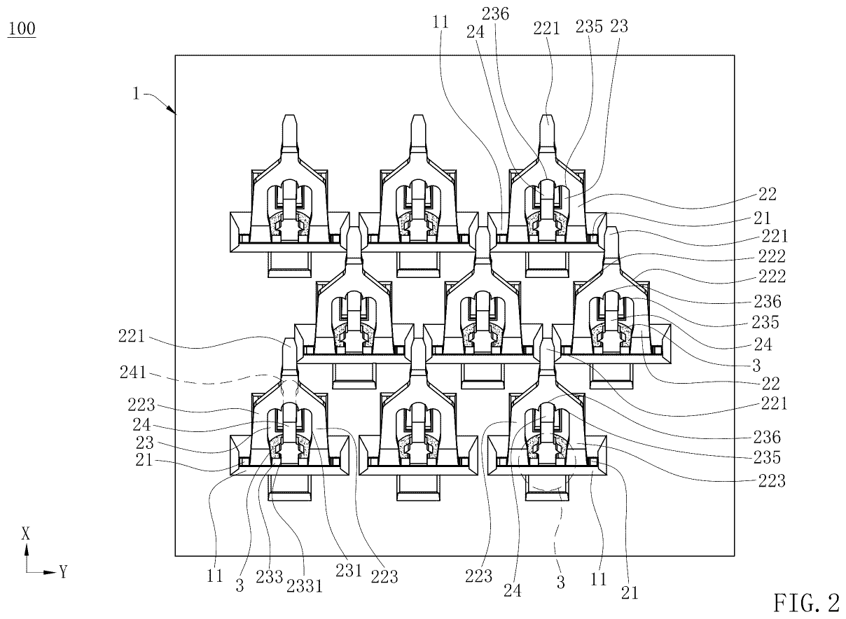

Referring to FIG. 2, FIG. 3 and FIG. 4, viewing downward from top thereof, a gap exists between the first edge 231 and the second elastic arm 24, and the solder ball 3 is partially exposed in the gap. The gap may be used for air convection, such that the heat generated by soldering the solder ball 3 may be easily dissipated.

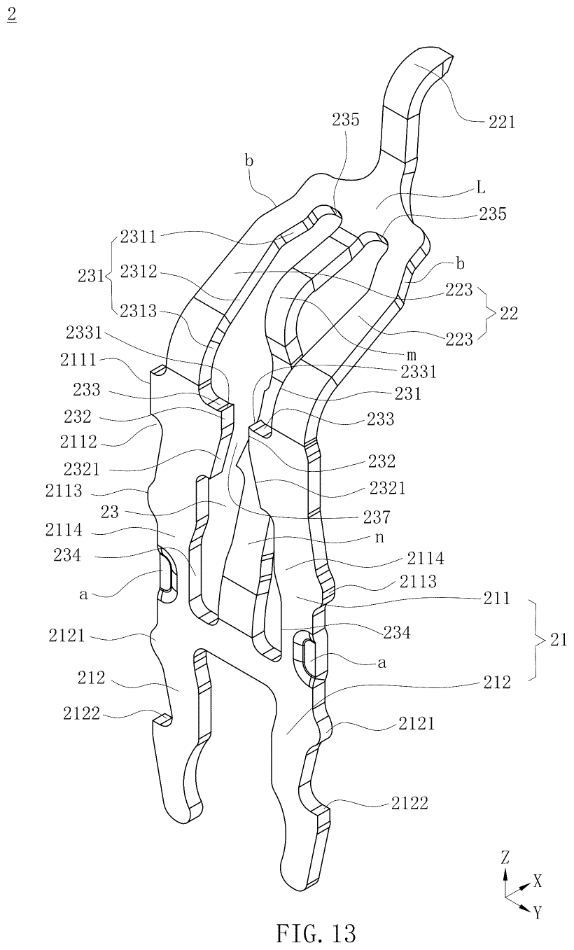

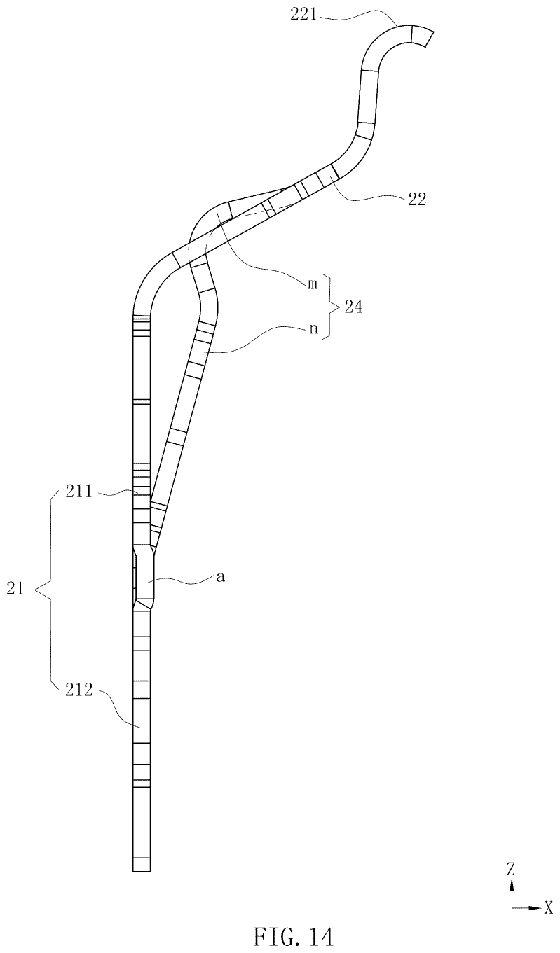

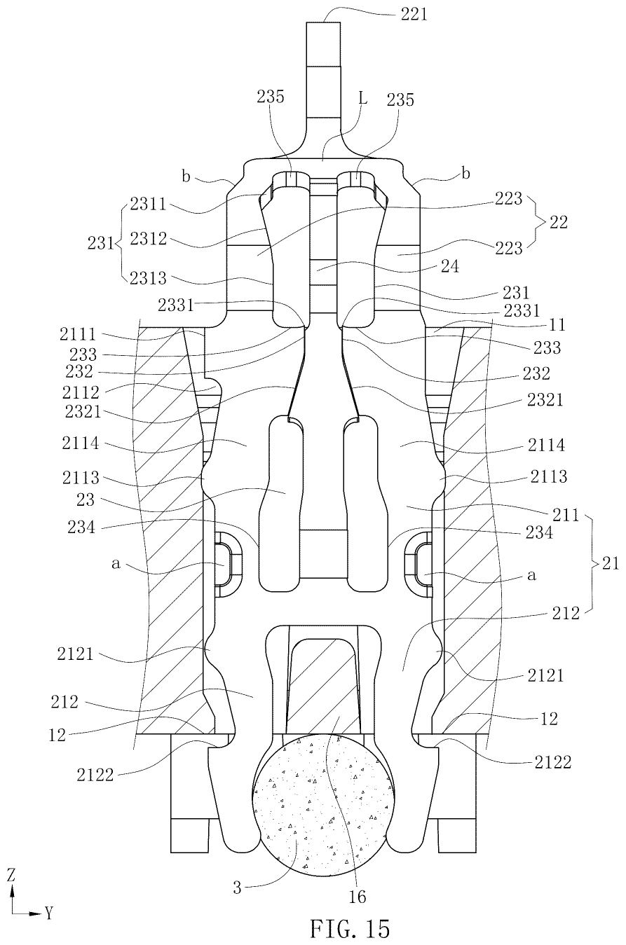

FIG. 13, FIG. 14 and FIG. 15 show a terminal 2 of an electrical connector 100 according to a second embodiment of the present invention, which is different from the terminal 2 in the first embodiment in that: an upper end of the second elastic arm 24 and a corresponding end of the separation 23 are integrally connected (that is, the second elastic arm 24 does not have the contact portion 241, and the upper end of the separation 23 does not have a second arc edge 236 provided between the two first arc edges 235). The second elastic arm 24 has a first portion m and a second portion n. The first portion m protrudes upward relative to the sub-arms 223, and the second portion n protrudes forward relative to the branches 2114. The two sub-arms 223 are located respectively at a left side and a right side of the first portion m, and the two branches 2114 are located respectively at a left side and a right side of the second portion n. The two sub-arms 223 bend inward toward the separation to form two bending sections b. The connecting portion L is connected to the two bending sections b, and a left side edge and a right side edge of the connecting portion L do not have taper edges 222, thereby a interval between the left side edge and the right side edge of the connecting portion L is equal forward from rear thereof. The first section 2311 extends obliquely upward from the second section 2312 and approaches the separation 23. The body portion 21 is protruding provided with two protruding bumps a at the left and right sides thereof, and the protruding bumps a are stopped forward by the corresponding inner wall of the accommodating slot 11 to limit the body portion 21 from moving forward. Other structures thereof are identical to those in the terminal 2 in the first embodiment, and are thus not hereinafter elaborated.

In sum, the electrical connector 100 according to certain embodiments of the present invention has the following beneficial effects:
(1) Each terminal 2 has a strip connecting edge 2111 at a left side edge or a right side edge of the body portion 21 to be connected to a strip 4, such that a width of the terminal 2 in the left-right direction is shorter, and the volume of the terminal 2 is thereby smaller, which is suitable for an electrical connector with higher terminal density and higher requirement in high frequency characteristics. Further, the strip 4 is removed before the terminals 2 are assembled into the accommodating slots 11, and the terminals 2 are then assembled into the accommodating slots 11 by a jig 5 abutting against the abutting region 233 between the bottom edge of the first edge 231 and the top edge of the second edge 232. Thus, there is no need to perform pre-breaking at the strip connecting edges 2111, and the terminals 2 do not easily fall from the strip connecting edges 2111 in the electroplating and transferring processes.
(2) The second elastic arm 24 protrudes forward relative to the body portion 21 and is thus staggered with the second edge 232 in the front-rear direction, such that a jig accommodating space 237 is formed between the two second edges 232, thereby allowing the jig 5 to be capable of entering the jig accommodating space 237 and adjusting the location of the terminal 2 in the left-right direction.
(3) The second elastic arm 24 of each terminal 2 and the first edges 231 and the first arc edges 235 of the separation 23 are formed to be separate from one another by blanking. In comparison to the case of tearing, the blanking technology may easily produce the second elastic arm 24 at a middle portion of the terminal 2. Further, during blanking, the cutting edge of the mold is an arc surface corresponding to the first arc edges 235, thus preventing the mold from providing a sharp corner near the location of the second elastic arm 24, thereby prolonging the usage lifespan of the mold and preventing from wearing of the sharp corner and dropped waste material that may affect the performance of the terminals 2.
(4) The highest point of the second arc edge 236 is higher than the highest point of the first arc edges 235, such that the length of the second elastic arm 24 may be longer, and the elasticity of the second elastic arm 24 is greater. Each of the left and right sides of the first elastic arm 22 has a tapered edge 222, and the highest point of the second arc edge 236 is higher than a lowest point of the tapered edges 222 but is lower than a highest point of the tapered edges 222, such that the portion of the terminal 2 between the two tapered edges 222 become smaller, thereby increasing the elasticity of the portion of the terminal 2 between the two tapered edges 222.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, configured to electrically connect a mating component to a circuit board, the electrical connector comprising:
an insulating body, having a plurality of accommodating slots running vertically through the insulating body; and
a plurality of terminals, respectively accommodated in the accommodating slots, wherein each of the terminals comprises:
a body portion, with a left side edge and a right side edge, wherein one of the left side edge and the right side edge has a strip connecting edge configured to be connected to a strip;
a first elastic arm, formed by bending and extending from an upper end of the body portion, wherein a top portion of the first elastic arm has a mating portion configured to abut upward against the mating component, and the mating portion is located in front of a bending location of the first elastic arm connected to the body portion;
a separation, provided on the body portion and the first elastic arm, wherein the separation divides the first elastic arm into two sub-arms separated in the left-right direction and divides the body portion into two branches separated in the left-right direction, each of a left side edge and a right side edge of the separation has a first edge and a second edge located below the first edge, the second edge protrudes inward toward the separation relative to the first edge, such that an abutting region is formed between a bottom edge of the first edge and a top edge of the second edge for a jig to abut against each of the terminals to be assembled downward in a corresponding one of the accommodating slots; and
a second elastic arm, wherein the two sub-arms and the two branches are located respectively at a left side and a right side of the second elastic arm, at least one end of the second elastic arm and a corresponding end of the separation are integrally connected, and when the mating component abuts downward against the mating portion to a final location, a conductive path sequentially through the mating portion, the sub-arm at the left side of the second elastic arm and the branch at the left side of the second elastic arm, another conductive path sequentially through the mating portion, the sub-arm at the right side of the second elastic arm and the branch at the right side of the second elastic arm, and a further conductive path sequentially through the mating portion, the second elastic arm and the body portion are formed between the mating component and the circuit board.

2. The electrical connector according to claim 1, wherein the first edge and the second elastic arm are formed to be separate from each other by blanking, the second edge and the second elastic arm are formed to be separate from each other by tearing, the abutting region is in an arc shape, and a connecting location of the abutting region and the second edge is higher than a lowest point of the arc shape.

3. The electrical connector according to claim 2, wherein each of the left side edge and the right side edge of the separation further has a third edge located below the second edge, the third edge extends upward from a lower end of the separation, and the third edge and the second elastic arm are formed to be separate from each other by blanking.

4. The electrical connector according to claim 3, wherein an oblique edge extends downward from the second edge to the third edge, the oblique edge and the second elastic arm are formed to be separate from each other by tearing, and a gap between two oblique edges at a left side and a right side of the separation gradually increases downward from top thereof.

5. The electrical connector according to claim 1, wherein a lower end of the second elastic arm and a lower end of the separation are integrally connected, an upper end of the second elastic arm and an upper end of the separation are broken and the second elastic arm has a contact portion, a surface of the contact portion and a surface of the mating portion are gold-plated, and a gold-plating thickness of the mating portion is greater than a gold-plating thickness of the contact portion.

6. The electrical connector according to claim 1, wherein the first edge and the second elastic arm are formed to be separate from each other by blanking, the body portion is provided with a pair of clamping portions configured to clamp a solder ball, and viewing downward from top thereof, a gap exists between the first edge and the second elastic arm, and the solder ball is partially exposed in the gap.

7. The electrical connector according to claim 1, wherein a lower end of the second elastic arm and a lower end of the separation are integrally connected, an upper end of the second elastic arm and an upper end of the separation are broken and the second elastic arm has a contact portion; when the mating component abuts against the mating portion to the final location, the contact portion is in contact with the first elastic arm; a contact location of the contact portion and the first elastic arm is located between the separation and the mating portion; each of a left side edge and a right side edge of the first elastic arm has a tapered edge, a spacing between two tapered edges gradually decreases forward from rear thereof, and a highest point of the separation is located between the two tapered edges.

8. The electrical connector according to claim 1, wherein each of a left side edge and a right side edge of the first elastic arm has a tapered edge, and a spacing between two tapered edges gradually decreases forward from rear thereof; an upper surface of the insulating body is protrudingly provided with a plurality of protruding blocks, each of the protruding blocks has a supporting surface configured to support the mating component, and when the mating component abuts downward against the mating portion to the final location, viewing downward from top thereof, the tapered edge is located between two adjacent supporting surfaces, and a rear edge of the supporting surface is located in front of a rear edge of the tapered edge.

9. The electrical connector according to claim 1, wherein a lower end of the second elastic arm and a lower end of the separation are integrally connected; the body portion comprises a base portion and a pair of clamping portions extending vertically downward from the base portion to clamp a solder ball, the base portion is in a vertical flat plate shape and a front surface and a rear surface thereof are plate surfaces, and the first elastic arm is connected to an upper end of the base portion.

10. The electrical connector according to claim 9, wherein each solder ball is stopped forward by a first stopping block and is stopped backward by two second stopping blocks, the first stopping block and the second stopping blocks are provided on the insulating body, the first stopping block is located in front of the clamping portions, and the second stopping blocks are located behind the clamping portions.

11. The electrical connector according to claim 1, wherein the first edge extends upward from the bending location of the first elastic arm connected to the body portion, and the second edge extends downward from the upper end of the body portion.

12. The electrical connector according to claim 1, wherein an upper end of the second elastic arm and an upper end of the separation are integrally connected, a lower end of the second elastic arm and a lower end of the separation are integrally connected, the second elastic arm has a first portion and a second portion, the first portion protrudes upward relative to the sub-arms, the second portion protrudes forward relative to the branches, the two sub-arms are located respectively at a left side and a right side of the first portion, and the two branches are located respectively at a left side and a right side of the second portion.

13. An electrical connector, comprising:
an insulating body, having a plurality of accommodating slots running vertically through the insulating body; and
a plurality of terminals, respectively accommodated in the accommodating slots, wherein each of the terminals comprises:
a base portion, being in a vertical flat plate shape and having a front surface and a rear surface thereof being plate surfaces;
a first elastic arm, formed by bending and extending from an upper end of the base portion, wherein a top portion of the first elastic arm has a mating portion configured to abut upward against a mating component, and the mating portion is located in front of the base portion;
a separation, provided on the base portion and the first elastic arm, wherein the separation divides the first elastic arm into two sub-arms separated in the left-right direction and divides the base portion into two branches separated in the left-right direction, a left corner and a right corner of an upper end of the separation have two first arc edges, the upper end of the separation has a second arc edge between the two first arc edges, the second arc edge is connected to the two first arc edges, a highest point of the two first arc edges is higher than a connecting point of the first arc edges and the second arc edge, and a highest point of the second arc edge is higher than the highest point of the first arc edges; and
a second elastic arm, wherein the second elastic arm and a lower end of the separation are integrally connected, an upper end of the second elastic arm is integrally connected to the second arc edge before forming and is broken from the second arc edge after forming, each of a left side edge and a right side edge of the separation has a first edge extending downward from the first arc edge, the first arc edge, the first edge and the second elastic arm are formed to be separate from one another by blanking, the second elastic arm has a contact portion, and when the mating component abuts downward against the mating portion to a final location, the contact portion is in contact with the first elastic arm, and a contact location of the contact portion and the first elastic arm is located in front of the separation.

14. The electrical connector according to claim 13, wherein the first edge has a first section connected to the first arc edge, a second section extending obliquely downward from the first section and approaching the separation and a third section extending downward from the second section to the upper end of the base portion, and a distance between two first sections at a left side and a right side of the separation is greater than a distance between two third sections at the left side and the right side of the separation.

15. The electrical connector according to claim 13, wherein each of a left side and a right side of the first elastic arm has a tapered edge, a spacing between two tapered edges gradually decreases forward from rear thereof, the highest point of the second arc edge is higher than a lowest point of the tapered edge but is lower than a highest point of the tapered edge, and the contact location of the contact portion and the first elastic arm is located between the separation and the mating portion.

16. The electrical connector according to claim 13, wherein each of a left side edge and a right side edge of the first elastic arm has a tapered edge, and a spacing between two tapered edges gradually decreases forward from rear thereof; an upper surface of the insulating body is protrudingly provided with a plurality of protruding blocks, each of the protruding blocks has a supporting surface configured to support the mating component, and when the mating component abuts downward against the mating portion to the final location, viewing downward from top thereof, the tapered edge is located between two adjacent supporting surfaces, and a rear edge of the supporting surface is located in front of a rear edge of the tapered edge.

17. The electrical connector according to claim 13, wherein when the mating component does not abut against the mating portion, the contact portion is not in contact with the first elastic arm; a surface of the contact portion and a surface of the mating portion are gold-plated, and a gold-plating thickness of the mating portion is greater than a gold-plating thickness of the contact portion.

18. The electrical connector according to claim 13, wherein a pair of clamping portions extend from the base portion and are configured to clamp a solder ball, and viewing downward from top thereof, the solder ball is partially exposed in the separation.

19. The electrical connector according to claim 13, wherein a pair of clamping portions extend vertically downward from the base portion and are configured to clamp a solder ball.

20. An electrical connector, comprising:
an insulating body, having a plurality of accommodating slots running vertically through the insulating body; and
a plurality of terminals, respectively accommodated in the accommodating slots, wherein each of the terminals comprises:
a base portion, being in a vertical flat plate shape and having a front surface and a rear surface thereof being plate surfaces;
a first elastic arm, formed by bending and extending from an upper end of the base portion, wherein a top portion of the first elastic arm has a mating portion configured to abut upward against a mating component, and the mating portion is located in front of a bending location of the first elastic arm connected to the base portion; and
a separation, provided on the base portion and the first elastic arm, wherein the separation divides the first elastic arm into two sub-arms separated in the left-right direction and divides the base portion into two branches separated in the left-right direction, each of a left side edge and a right side edge of the separation has a first edge and a second edge located below the first edge, the first edge extends upward from the bending location of the first elastic arm connected to the base portion, the second edge extends downward from the upper end of the base portion, and the second edge protrudes inward toward the separation relative to the first edge, such that the upper end of the base portion forms an abutting region between a bottom edge of the first edge and a top edge of the second edge for a jig to abut against each of the terminals to be assembled downward in a corresponding one of the accommodating slots; and a jig accommodating space is formed between two second edges at the left side edge and the right side edge, allowing the jig to enter the jig accommodating space to adjust locations of the terminals in the left-right direction.
